(19) United States
(12) Patent Application Publication
(10) Pub. No.: US 2026/0141368 A1
(43) Pub. Date: May 21, 2026

(54) PERSONALIZED VENDING MACHINE

(71) Applicant: Universal City Studios LLC, Universal City, CA (US)

(72) Inventors: Bobbi Michelle Jordan, Orlando, FL (US); Jon Francis Craine, Orlando, FL (US); Elise Ann Sockman, Orlando, FL (US)

(21) Appl. No.: 19/391,808

(22) Filed: Nov. 17, 2025

Related U.S. Application Data
(60) Provisional application No. 63/722,892, filed on Nov. 20, 2024.

(51) Int. Cl. G06Q 20/18; G07F 11/02

(52) U.S. Cl. CPC G06Q 20/18; G07F 11/02

(57) ABSTRACT

A vending machine includes a housing that may store one or more available items of merchandise and one or more restricted items of merchandise. The vending machine also includes a controller that may determine one or more qualifications of a guest, and present, via a display in a transparent configuration, the available items of merchandise to the guest based on the one or more qualifications of the guest. The controller may also present, via a display in an obscured configuration, the restricted items of merchandise to the guest. The controller may also receive an indication of a choice from the guest indicative of a selected item of merchandise, where the selected item of merchandise is within the available items of merchandise and may trigger the provision of the selected item of merchandise to the guest via a pickup port.

### CROSS-REFERENCE TO RELATED APPLICATION

This application claims priority to and the benefit of U.S. Provisional Application No. 63/722,892 entitled “PERSONALIZED VENDING MACHINE” and filed Nov. 20, 2024, which is incorporated by reference herein in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Amusement parks and other entertainment venues often provide a selection of unique attractions. For example, an amusement park may include a variety of attractions, such as rides, and show performances, to entertain guests. These attractions may also have accompanied merchandise.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, a vending machine includes a housing that may store at least one or more available items of merchandise or one or more restricted items of merchandise. The vending machine also includes a controller that may determine one or more qualifications of a guest, and present, via a display in a transparent configuration, the one or more available items of merchandise to the guest based on the one or more qualifications of the guest. The controller may also present, via a display in an obscured configuration, the one or more restricted items of merchandise to the guest. The controller may also receive an indication of a choice from the guest indicative of a selected item of merchandise, where the selected item of merchandise is within the one or more available items of merchandise and may trigger the provision of the selected item of merchandise to the guest via a pickup port.

In an embodiment, a method for vending includes determining qualifications associated with a guest and determining available items of merchandise based on the qualifications. The method also includes displaying the available items of merchandise through viewing panels disposed on a vending machine in a transparent configuration and displaying restricted items of merchandise through viewing panels disposed on the vending machine in an obscured configuration. The method further includes receiving a guest input indicative of a desired item of merchandise, where the desired item of merchandise is within the one or more available items of merchandise and presenting the desired item of merchandise to the guest.

In an embodiment, a vending machine for an entertainment venue includes items of merchandise and viewing panels, where the viewing panels may transition between an obscured configuration and a transparent configuration upon receiving an electrical signal. The vending machine may also include a controller that may determine qualifications of a guest, where the qualifications include completing one or more actions associated with the entertainment venue. The vending machine may further send the electrical signal to the viewing panels based on the qualifications.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an embodiment of a personalized vending machine within an entertainment venue, in accordance with the present disclosure;

FIG. 2 is a schematic illustration of an embodiment of the personalized vending machine, in accordance with the present disclosure;

FIG. 3 is a schematic illustration of an embodiment of the personalized vending machine, in accordance with the present disclosure;

FIG. 4 is a schematic illustration of an embodiment of the personalized vending machine transitioning from a first configuration to a second configuration, in accordance with the present disclosure;

FIG. 5 is a schematic illustration of an embodiment of the personalized vending machine, in accordance with the present disclosure; and

FIG. 6 is a flow diagram describing an embodiment of a guest interaction with the personalized vending machine, in accordance with the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

It is presently recognized that guests of an entertainment venue may participate in games, participate in rides, and/or may perform tasks throughout the entertainment venue. It is also presently recognized that upon completion of the game, ride, and/or task, a guest may obtain an achievement or a prize. As such, it is also presently recognized it would be desirable to enable the guest to purchase or otherwise obtain an item related to the game or task based on acquiring the achievement or prize.

The present disclosure is directed to personalized vending machine (e.g., personalized coin machine, personalized slot machine, personalized automat), which may be utilized within an entertainment venue (e.g., amusement park, theatre, sports arena, hotel, restaurant, retail location, and/or any other type of venue). The personalized vending machine may identify a guest's qualifications (e.g., achievements, status, level, rank, age, participation, experience) and/or an item (e.g., quest item, blaster, watch) carried by or associated with the guest and determine merchandise (e.g., toys (e.g., plush toys), items, food, prizes, etc.) within the machine may be purchased or obtained by the guest, based on the qualifications.

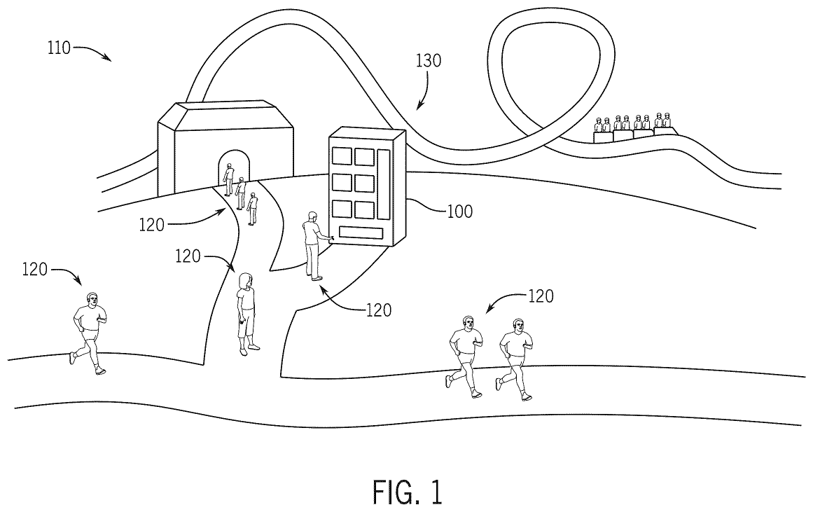

With the preceding in mind, FIG. 1 is a view of an embodiment of a personalized vending machine 100 located within an entertainment venue 110. In an embodiment, the personalized vending machine 100 may include a variety of items of merchandise capable of being purchased or otherwise obtained by guests 120 of the entertainment venue 110. The guests 120 may approach the personalized vending machine 100 where they may then purchase or otherwise obtain one or more items of merchandise. In accordance with this disclosure, the guests 120 may experience a personalized encounter with the personalized vending machine 100 based on their identity and/or their qualifications (e.g., status, level). A detailed description of the purchasing or obtaining of items of merchandise from the personalized vending machine 100 can be found below.

The personalized vending machine 100 may be located at any position within the entertainment venue 110, for example, within common areas, restaurants, near attractions, and so forth. In an embodiment, the personalized vending machine 100 may be located outside of the entertainment venue 110, and may be associated with one or more aspects (e.g., rides, themes, shows, movies) of the entertainment venue 110. Further, the personalized vending machine 100 may be located proximate an area of high guest traffic to increase sales and/or guest interaction with the personalized vending machine 100. For example, in the illustrated example, the personalized vending machine 100 is proximate to a ride attraction 130 of the entertainment venue 110. In this way, guests 120 using the personalized vending machine 100 may be enticed to also partake in the ride attraction 130 and/or guests 120 partaking in the ride attraction 130 may be enticed to visit the personalized vending machine 100.

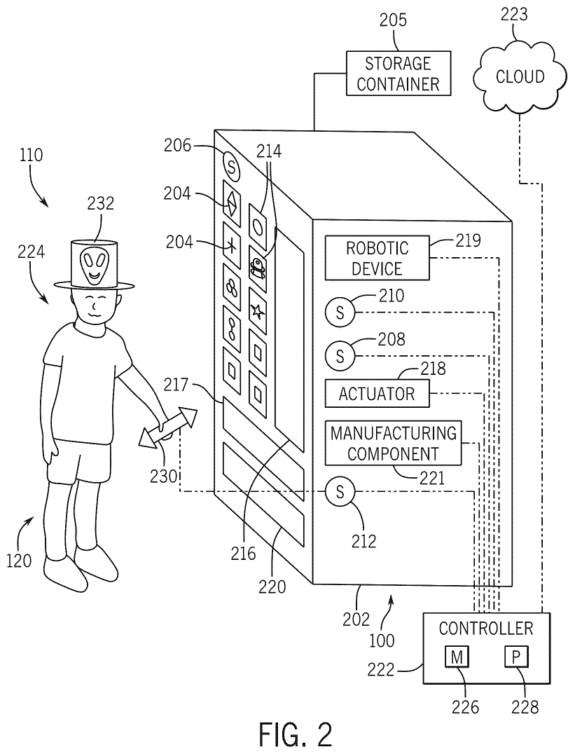

Turning now to FIG. 2, a perspective view of a guest 120 interacting with the personalized vending machine 100 is shown. The personalized vending machine 100 may include a housing 202 capable of storing items of merchandise 204 to be purchased or otherwise obtained by the guest 120. The items of merchandise 204 may be stored within the housing 202 in any suitable way. For example, the housing 202 may further include shelves and/or columns configured to hold (e.g., securely hold) items of merchandise 204 within the housing 202. In an embodiment, multiple similar items of merchandise 204 may be held in the same row or column of the housing 202. As such, in an embodiment where guest 120 purchases or otherwise obtains the item of merchandise 204, a similar item of merchandise may remain within the housing 202. In an embodiment, the items of merchandise 204 are stored separate from the housing 202 in storage container 205, and may be transferred into the housing or to a location proximate the housing 202 upon receiving a signal that the guest 120 has selected the item of merchandise 204.

As described above, the personalized vending machine 100 may include a variety (e.g., different types) of items of merchandise 204. For example, the items of merchandise 204 may include toys, such as plush toys (e.g., stuffed animals, soft toys), hard toys (e.g., plastic toys, building toys, action figures, musical toys, action toys), electronic toys (e.g., light up toys, radio-controlled toys), and/or any other suitable type of toy. Further, the items of merchandise 204 may include apparel, such as, hats, shirts, pants, shoes, backpacks, jewelry, and/or any other suitable apparel. Further, the items of merchandise 204 may include any suitable food and/or beverages. Further, the items of merchandise 204 may include electronics such as, smart watches, smart phones, audio outputting devices, and/or any other suitable electronics. In an embodiment, the items of merchandise 204 may be at least partially associated with the entertainment venue 110 and/or an aspect of the entertainment venue 110, such as the ride attraction 130 of FIG. 1. For example, a toy type merchandise 204 may be designed to replicate a character associated with the entertainment venue 110 or more specifically associated with the ride attraction 130.

In an embodiment, the housing 202 may further include one or more viewing panels 214, located on a front of the personalized vending machine 100, capable of displaying the items of merchandise 204 to the guest 120. In an embodiment, the one or more viewing panels 214 may be orientated to display a single item of merchandise 204. In an embodiment, the one or more viewing panels 214 may be capable of displaying two or more items of merchandise 204. For example, the housing 202 may include one viewing panel 214, capable of displaying all of the items of merchandise 204 within the personalized vending machine 100.

In an embodiment, the items of merchandise 204 may be displayed (e.g., displayed by the one or more viewing panels 214) and/or may be capable of being obtained based on whether the items of merchandise 204 are restricted and/or based on whether the guest 120 is eligible. For example, items of merchandise 204 may be restricted based on the guest 102 qualifications (e.g., age, level, status), a time (e.g., a time of year, season, time of day), a current quantity of items of merchandise 204 (e.g., stock), and/or any other factor. The concept of the guest 102 qualifications will be explained in detail below.

The viewing panels 214 may include any material suitable to enable guest 120 to view available items of merchandise 204a (e.g., eligible, not restricted, called “available items of merchandise” herein). For example, the viewing panels 214 may be a transparent or semi-transparent material such as glass (e.g., tempered glass, laminated glass, wired glass, shatterproof glass) or hard plastics. In an embodiment, the viewing panels 214 may include smart glass (e.g., privacy smart glass, privacy glass, switchable glass) configured to transition between a transparent view and an obscured (e.g., translucent, blurred, opaque, silhouette) view. In this way, the personalized vending machine 100 may display items of merchandise 204 available to the guest 120 (“available item(s) of merchandise”) 204a using the transparent view configuration of the smart glass and display items of merchandise 204b not available (e.g., restricted, out of stock items, called “restricted item(s) of merchandise” herein) using the obscured view configuration. For example, upon determining the guest 120 qualifications, the controller 222 may send an electrical signal to the one or more viewing panels 214 to change configuration (e.g., change from the transparent view to the obscured view or vice versa) such that only the available items of merchandise 204a are visible to the guest 120. It should be understood that the available items of merchandise 204a and the restricted items of merchandise 204b are non-overlapping with respect to a particular guest 120. That is, an item of merchandise 204 cannot be both an available item of merchandise 204a and a restricted item of merchandise 204b with respect to a particular guest 120. Based on a guest's qualifications, for example, and as described in more detail below, an item of merchandise 204 may be transitioned from a restricted item of merchandise 204b to an available item of merchandise 204a.

In an embodiment, one or more viewing panels 214 may be digital displays configured to display a digital representation of the items of merchandise 204 to the guest 120. For example, the digital displays may include LED, OLED, LCD, or any other suitable electronic display capable of displaying an image to the guest 120. The digital display may further include information related to the available items of merchandise 204a, such as, for example, price information, name information, nutritional information, and/or any other information suitable to be displayed to the guest 120. Additionally or alternatively, the one or more viewing panels 214 (e.g., the digital display) may include or present information related to the restricted items of merchandise 204b. Indeed, in some instances, the information presented related to the restricted items of merchandise 204b (e.g., only price, only name) may be less than the information presented related to the available items of merchandise 204a (e.g., price information, name information, nutritional information, and/or any other suitable information). In an embodiment, the digital display may also include information relating to a qualification (e.g., task status, guest level) of the guest 120. For example, the digital display may inform the guest 120 a certain item of merchandise 204 is currently a restricted item of merchandise 204b, but may be accessed after reaching a certain level and/or completing a task (e.g., quest) to obtain the required qualification.

In an embodiment, the viewing panels 214 may be a transparent digital screen (e.g., transparent LCD, transparent OLED, transparent LED), enabling the guest 120 to view within the housing 202, while also overlaying a digital image onto the viewing panels 214. In this way, the viewing panels 214 may provide information related to the respective items of merchandise 204 corresponding to one or more viewing panels 214. For example, the viewing panel 214 may display information such as a price, nutritional facts, associated graphics, merchandise name, and/or other information associated with the item of merchandise 204 located within the housing 202, viewable by the guest 120 through the transparent digital screen of the one or more viewing panels 214.

In an embodiment, the personalized vending machine 100 may include a selection menu 216, positioned on the outside of the housing 202 or proximate the personalized vending machine 100, capable of receiving guest 120 input and/or displaying items of merchandise 204 information. For example, the selection menu 216 may include a touchscreen capable of receiving guest 120 input relating to a desired item of merchandise 204 within the personalized vending machine 100. In an embodiment, the selection menu 216 is not digital, and may instead include physical buttons, capable of receiving guest 120 input related to the desired item of merchandise 204. In any case, the guest 120 may view the available items of merchandise 204a via the viewing panels 214 and select the selected item(s) of merchandise 204 via the selection menu 216 from the available items of merchandise 204a. In an embodiment, the selection menu 216 may display available items of merchandise 204a as selectable icons and may display restricted items of merchandise 204b as non-selectable icons.

In an embodiment, the one or more viewing panels 214 and the selection menu 216 may include the same screen or screens. For example, the housing 202 of the personalized vending machine 100 may include a single screen including the available items of merchandise 204a and all relevant information associated with the item of merchandise 204. The single screen may also be capable of receiving guest input to select an available item of merchandise 204a. In an embodiment, the one or more viewing panels 214 may be distinct from the selection menu 216.

It should be noted that the selection menu 216 is not limited to being located on the housing 202, and may instead, or in addition, be located on a mobile device of the guest 120 or another suitable location. For instance, the guest 120 may select an item of merchandise 204 for purchase through a mobile app associated with the personalized vending machine 100.

The controller 222 may also receive an indication of a non-monetary payment from the guest indicative of the selected item of merchandise 204. In an embodiment, the payment may include a non-monetary currency (e.g., achievements, stamps, points, credits associated with one or more aspects of the entertainment venue (e.g., credits pertaining to a game played throughout the entertainment venue). In an embodiment, the payment may include a mixture of monetary currency and non-monetary currency (e.g., $10 and 120 credits). In an embodiment, the payment may be the same as the guest qualification or at least partially associated with the guest qualification. In any case, the personalized vending machine 100 may receive the payment digitally and/or may receive the payment physically. For example, the personalized vending machine 100 may include a payment receptacle 217 configured to receive physical currency, such as paper bills or coins. It should be noted that payment may not be needed, and the qualifications, as discussed above, may be sufficient to obtain available items of merchandise.

Upon purchasing or otherwise obtaining one or more items of merchandise 204 by the guest 120, the personalized vending machine 100 may retrieve the items of merchandise 204 selected via any suitable retrieving method. In an embodiment, upon selection (e.g., input on the selection menu 216) of an item of merchandise 204 by the guest 120, and upon receiving the indication of a non-monetary payment, the controller 222 may receive the selection and further send a control signal to one or more actuators 218 within the personalized vending machine 100 to produce the item of merchandise 204 to the guest 120. For example, the controller 222 may send a control signal that may trigger one or more actuators 218 to cause the item of merchandise 204 to be unlatched from within the housing 202, and made retrievable to the guest 120 via, for example, a pickup port 220 (e.g., merchandise dispenser).

In an embodiment, the personalized vending machine 100 may include a robotic device 219 (e.g., robotic arm) capable of retrieving the item of merchandise 204 without requiring the item of merchandise 204 to fall (e.g., drop to the pickup port 220 for retrieval). For example, the robotic device 219 may grab or obtain the item of merchandise 204 within the housing 202, where it may then transport the item of merchandise 204 to the pickup port 220.

In an embodiment, the personalized vending machine 100 may include manufacturing components 221 capable of manufacturing and/or modifying the item of merchandise 204 upon receiving a control signal from the controller 222. For example, an item of merchandise 204 (e.g., apparel) may be customized (e.g., customized based on the guest's 120 desires) by the manufacturing components 221, where the item of merchandise 204 may then be transported or otherwise made available to the guest 120 (e.g., at the pickup port 220).

Pickup port 220 may be positioned at any location on or proximate the housing 202 of the personalized vending machine 100. For example, the pickup port 220 may be located on a front, a side, and/or a back of the housing 202. Further, the pickup port 220 may include any shape, size, orientation suitable to enable the guest 120 to retrieve a purchased and/or obtained item of merchandise 204 from the personalized vending machine 100. In an embodiment, the pickup port 220 may include a door capable of opening to allow the guest 120 to grab or otherwise retrieve the item of merchandise 204.

In an embodiment, the personalized vending machine 100 may personalize a selection of merchandise 204 based on an identity of the guest 120 and/or qualifications of the guest 120. For example, the housing 202 of the personalized vending machine 100 may include one or more sensors 206, 208, 210 capable of determining the guest 120 is within a vicinity (e.g., the guest 120 is physically near (e.g., 1 ft, 2 ft, 3 ft, 4 ft, 5 ft, 6 ft, etc.) the personalized vending machine 100) of the personalized vending machine 100, a physical feature of the guest 120, the identity of the guest 120, and/or a qualification of the guest 120, as described in more detail below. Upon determining the guest 120 is within the vicinity (e.g., boundary distance) of the personalized vending machine 100, and further determining the identity of the guest 120, the personalized vending machine 100 may display, via the one or more viewing panels 214 and/or the selection menu 216, a selection of available items of merchandise 204a. In an embodiment, the guest's 120 identity may include a personalization profile associated with the entertainment venue 110.

In an embodiment, the personalized vending machine 100 may include a proximity sensor 208 capable of detecting the guest 120 is within the vicinity (e.g., boundary distance) of the personalized vending machine 100. For example, proximity sensor 208 may include a motion sensor, video sensor, and/or any other sensor or device suitable for detecting or determining the guest's 120 location (e.g., proximity). The controller 222 may then determine whether the guest's 120 location is within the vicinity (e.g., boundary distance) of the personalized vending machine 100. Further, the proximity sensor 208 may detect a direction of the guest 120, for example, if the guest 120 is facing the personalized vending machine 100. The proximity sensor 208 may send sensor data (e.g., data indicative of a presence of the guest 120, detected data) to the controller 222 to determine whether the guest 120 is within the vicinity of the personalized vending machine 100, and/or whether the guest 120 is facing the personalized vending machine 100. Specifically, the controller 222 may determine whether the guest 120 is intending to interact with the personalized vending machine 100, or if, for example, the guest 120 is passing by. Upon determination that the guest 120 is within the vicinity (e.g., boundary distance) of and/or facing the personalized vending machine 100, the controller 222 may further detect and/or determine the identity of the guest 120 and/or an object associated with the guest 120.

For example, in an embodiment, the personalized vending machine 100 may include a visual sensor 206, configured to detect one or more aspects of the guest 120. For example, the visual sensor 206 may include video monitoring through a camera or another type of video producing device. In this way, the visual sensor 206 may be capable of detecting one or more aspects of the guest's face 224 or body such as, facial structure and/or eye orientation, in the form of detected data. In the context of this disclosure, the detected data refers to data received by one or more sensors, such as video detection data, voice detection data, or other detection of guest 120 characteristics. Furthermore, the controller 222 may include memory 226, that may be capable of storing a plurality of stored data that may be used to determine the identity of the guest 120. For example, the memory 226 of the controller 222 may include stored data associated with the guest 120 (e.g., a stored facial structure, a stored eye orientation). Upon detection of the detected data, which may include one or more aspects of the guest's 120 face, the visual sensor 206 may send detected data to the controller 222. The controller 222 may then determine the guest's 120 identity via, for example, matching the received detected data with the stored data stored within the memory 226. In an embodiment, the guest 120 may have previously stored the stored data in the memory 226 during, for example, a sign-up for the entertainment venue 110. In any case, upon identification of the guest 120, the personalized vending machine 100 may further display personalized items of merchandise 204 and/or interact with the guest 120 in a personalized way.

In an embodiment, the personalized vending machine 100 may further include an audio sensor 210 in addition or in place of the visual sensor 206, configured to detect one or more aspects of the guest 120 voice, as detected data. In addition to video data, detected data may take other forms, such as voice data. For example, the audio sensor 210 may include a microphone or another type of audio recording device capable of detecting one or more aspects of the guest's 120 voice (e.g., tonality, frequency, voice biometrics), as detected data. Furthermore, the memory 226 of the controller 222 may be capable of storing a plurality of stored data, such as data indicative of the guest's 120 voice. For example, the memory 226 of the controller 222 may include previous voice information associated with the guest 120 as stored data. Upon detection of one or more aspects of the guest's 120 voice, the audio sensor 210 may send the detected data (e.g., the guest's voice information) to the controller 222. The controller 222 may then determine the guest's 120 identity via, for example, matching the received detected data sent from the audio sensor 210 with the stored data within the memory 226. In an embodiment, the guest 120 may have previously stored the stored data (e.g., voice information) in the memory 226 during, for example, a sign-up for the entertainment venue 110. In any case, upon identification of the guest 120, the personalized vending machine 100 may further display personalized items of merchandise 204 and/or interact with the guest 120 in a personalized way.

In an embodiment, the personalized vending machine 100 may further include a communication node 212 in addition to or in place of the visual sensor 206, and the audio sensor 210, configured to detect an object 230 (e.g., smart watch, smart device, entertainment venue object) associated with the guest 120. For example, the communication node 212 may include communication components capable of communicating with the object 230 worn by the guest 120, held by the guest 120, and/or proximate the guest 120. The object 230 may be an electrical object capable of communicating with the communication node 212 via any suitable communication means, for example, WiFi, Bluetooth, radio, NearLink, near-field communication (NFC), LPWAN, ultra-wideband (UWB), or any other suitable wireless communication technique. In any case, the controller 222 may receive data indicative of the object 230 from the communication node 212 where the controller 222 may then determine an identity of the guest 120. For example, the memory 226 of the controller 222 may include stored data that associates the object 230 with the identity of the guest 120. Upon detection of the object 230 and further identification of the guest 120, the personalized vending machine 100 may display personalized items of merchandise 204 and/or interact with the guest 120 in a personalized way.

In an embodiment, the sensors 206, 208, 210, and communication node 212 may transmit the detected data (e.g., guest identification information, guest voice information, or the data indicative of the object) to the controller 222 using communication lines, such as electric cables or fiber optic cables. In an embodiment, the sensors 206, 208, 210, and communication node 212 may transmit detected data (e.g., guest identification information, guest voice information, or the data indicative of the object) wirelessly to the controller 222. The controller 222 may further include one or more processors 228 (e.g., processing circuitry). The one or more processors 228 may include one or more microprocessors, which may execute software for controlling the personalized vending machine 100 (e.g., components of the personalized vending machine 100). The one or more processors 228 may include multiple microprocessors, one or more “general-purpose” microprocessors, one or more special-purpose microprocessors, and/or one or more application specific integrated circuits (ASICS), or some combination thereof. For example, the one or more processors 228 may include one or more reduced instruction set (RISC) processors. In an embodiment, the controller 222 may include additional components, such as receivers and transmitters for receiving or transmitting data (e.g., via radiofrequency, optical frequency, other communication frequencies, or any combination thereof).

In an embodiment, the guest 120 may have various qualifications associated with their identity. Qualifications may include a status (e.g., a guest's 120 status partaking in a game, quest, task), a level (e.g., lvl. 20, platinum entertainment park guest, rank), rewards, prizes, achievements, etc. For example, the guest 120 may participate in a game (e.g., quest) of the entertainment venue 110 with the goal or purpose of uncovering a secret location (e.g., visiting a certain region of the entertainment venue 110). The guest's 120 status or progress (e.g., secret location found, secret location not found) for the game may be tracked (e.g., a cloud-based tracking system) and associated with the guest's 120 identity. For example, upon completion of a game, event, ride, etc., qualification data may be sent (e.g., wirelessly sent) and stored in cloud 223, where the controller 222 may communicate with the cloud 223 to obtain the qualification data to determine guest 120 eligibility.

In an embodiment, upon identification of the guest 120, the personalized vending machine 100 may determine qualifications of the guest 120 to further personalize the guest's 120 experience. For example, the personalized vending machine 100 may determine guest 120 has obtained a certain level (e.g., lvl. 37) that may be associated with one or more aspects of the entertainment venue 110. The level, associated with one or more aspects of the entertainment venue 110, may be increased based on an amount of participation (e.g., completion of quests, participation in rides, participation in games, money spent, occurrences of visiting the entertainment venue 110, etc.). Further, based on the guest's 120 level (e.g., lvl. 37), the personalized vending machine 100 may determine items of merchandise 204 that are available items of merchandise 204a for the guest 120.

For example, the personalized vending machine 100 may associate the items of merchandise 204 with a given threshold level. That is, certain items of merchandise 204 within the personalized vending machine 100 may be restricted items of merchandise 204b to guests 120 who do not have a minimum level associated with their identity. These same items of merchandise may be available items of merchandise 204a to guests 120 who have a level greater than or equal to a threshold level. In this way, guests 120 may purchase or obtain available items of merchandise 204a based on their participation in one or more aspects of the entertainment venue 110. In this way, participation in one or more aspects of the entertainment venue 110 may be increased.

In an embodiment, the personalized vending machine 100 may determine guest 120 has completed a task and/or obtained an achievement that may be associated with one or more aspects of the entertainment venue 110. The completion of the task and or obtaining of an achievement may designate items of merchandise 204 to be available items of merchandise 204a to the guest 120, enabling the guest 120 to purchase or obtain available items of merchandise 204a without meeting a specific threshold level. For example, guest 120 may be tasked with visiting a location (e.g., restaurant, ride attraction) of the entertainment venue 110. Upon entering a vicinity of the location and/or partaking in activity (e.g., purchasing food, riding the ride attraction) of the location, the guest 120 may complete the given task, and may be rewarded an achievement and/or prize (e.g., physical prize, digital prize). The achievement or prize may be associated with the identity of the guest 120 and stored within the memory 226 of the controller 222 of the personalized vending machine 100 or within the object 230. Upon identification of the guest 120 at the personalized vending machine 100, and further determination of the qualifications (e.g., task completed qualification, achievement, prize) associated with the guest's 120 identity, the personalized vending machine 100 may display, via the one or more viewing panels 214 and/or the selection menu 216, available items of merchandise 204a at least partially associated with the qualifications, for example, the achievement for completing the task. The controller 222 may further enable the guest 120 to select a desired item of merchandise to purchase or otherwise obtain based on the qualifications of the guest 120 from the available items of merchandise 204a.

In an embodiment, personalized vending machine 100 may determine qualifications not associated with identity of the guest 120. For example, the personalized vending machine 100 (e.g., the controller 222) may determine whether the guest 120 is wearing certain items of apparel that may qualify the guest 120 for available items of merchandise 204a. For example, visual sensor 206 (e.g., video capturing device) may receive video data of the guest 120 (e.g., clothing worn by the guest 120) where the visual sensor 206 may then send the video data to the controller 222 to determine the qualifications of the guest 120 based on, for example, wearing entertainment themed apparel, character themed apparel, etc. Based on the qualifications of the guest 120, certain items of merchandise 204 may be available items of merchandise 204a.

In the illustrated example in FIG. 2, the personalized vending machine 100, via the visual sensor 206, may capture video data and/or image data of the entertainment venue themed hat 232 worn by the guest 120. The visual sensor 206 may then send or otherwise communicate the video data or image data to the controller 222 to determine the entertainment venue themed hat 232 qualifies the guest 120 to be eligible for available items of merchandise 204a, via, for example, matching of the video data with previously stored video data and/or image data within memory 226. Upon determining the guest 120 qualifies, the personalized vending machine 100 may enable available items of merchandise 204a (e.g., candy associated with the entertainment venue themed hat 232) to be purchased or otherwise obtained by the guest 120.

In an embodiment, the personalized vending machine 100 may determine qualifications of guest 120 based on the object 230, without the need to determine the identity of the guest 120. In an embodiment, the object 230 held or worn by the guest 120 may qualify the guest 120 for available items of merchandise 204a. For example, the object 230 may be obtained as a prize or reward for completing a task or quest associated with the entertainment venue 110. The object 230 may be identified or detected by the personalized vending machine 100 in any suitable way. For example, the visual sensor 206 may capture video data and/or image data, where upon receiving the video data and/or image data, the controller 222 may then determine whether the object 230 qualifies the guest 120 for available items of merchandise 204a. In an embodiment, the object 230 may include communication components capable of alerting or otherwise communicating its proximate position to the personalized vending machine 100, where the controller 222 may then determine the object 230 qualifies the guest 120 for available items of merchandise 204a. In an embodiment, the guest 120 may “tap” or otherwise signal the personalized vending machine 100 to view the available items of merchandise 204a associated with the object 230 and/or obtain the available items of merchandise 204a associated with the object 230. In an embodiment, the object 230 may be a mobile device, capable of communicating a prize, achievement, reward, etc. to the controller 222 to enable purchasing or obtaining available items of merchandise 204a. In any case, the personalized vending machine 100 may enable guest 120 to purchase or otherwise obtain available items of merchandise 204a based on the object 230 within the vicinity (e.g., physically near, within the boundary distance) of the personalized vending machine 100, with or without determining the identity of the guest 120.

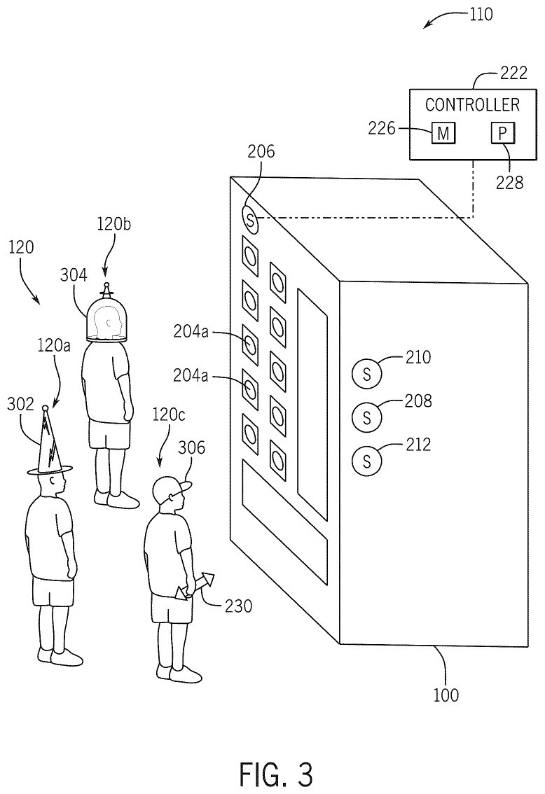

FIG. 3 illustrates an embodiment of the personalized vending machine 100 capable of detecting more than one guest 120 (e.g., two or more guests 120 including guest 120a, 120b, and 120c). In an embodiment, the personalized vending machine 100 may designate one or more items of merchandise 204 as available item(s) of merchandise 204a, for purchase or obtaining, based on qualifications of two or more guests 120. Determination of the qualifications of the two or more guests 120 by the controller 222 may require identification of each guest 120a, 120b, 120c or may proceed as described above based on, for example, an object 230 within the vicinity, without requiring identification of each guest 120a, 120b, 120c. For example, each guest 120a, 120b, and 120c may have a specific and/or different qualification (e.g., trait, achievement) associated with each identity. As such, the personalized vending machine 100 may detect, by one or more methods as discussed above, the identity of each guest 120a, 120b, 120c. In an embodiment, available items of merchandise 204a may require a combination of qualifications between two or more guests 120 for such available items of merchandise 204a to be purchased or obtained. For example, in the illustrated embodiment, the personalized vending machine 100 may include an available item of merchandise 204a that may require three separate qualifications (e.g., traits, space trait, magic trait, sport trait) between three separate guests 120.

The personalized vending machine 100 may determine the two or more guests 120 are within the vicinity (e.g., the guests 120 are physically near (e.g., within 1 meter (m), 2 m, 3 m, 4 m, 5 m, 6 m, etc., within the boundary distance) of the personalized vending machine 100) of the personalized vending machine 100 via one or more of the sensing methods discussed above (e.g., the visual sensor 206, the proximity sensor 208, the audio sensor 210). The personalized vending machine 100 may then determine the identity of each guest 120a, 120b, and 120c, along with accompanying qualifications (e.g., traits, status, levels, prizes, achievements, etc.) of each guest 120a, 120b, and 120c. Upon determination that the two or more guests 120 have the qualifications required (e.g., space trait, magic trait, sport trait), the personalized vending machine 100 may enable the two or more guests 120 to purchase or otherwise obtain the available items of merchandise 204a by collaborating. Thus, a guest 120a may obtain an available item of merchandise 204a by collaborating with one or more additional guests 120b, 120c. In this way, guests 120a, 120b, and 120c may be influenced to collaborate or interact with other guests 120a, 120b, and 120c within the entertainment venue 110, increasing participation.

In an embodiment, determination of the qualifications of the two or more guests 120 by the controller 222 may not require identification of guests 120a, 120b, 120c. For example, each guest 120a, 120b, and 120c may wear and/or hold specific clothing or items that may qualify two or more guest 120 to purchase or otherwise obtain available items of merchandise 204a when aggregated (e.g., combined with other items or objects). In the illustrated embodiment, the personalized vending machine 100 may include an available item of merchandise 204a that may require three separate qualifications (e.g., hats) between the three separate guests 120a, 120b, 120c, for such available item of merchandise 204a to be purchased or otherwise obtained.

The personalized vending machine 100 may determine the two or more guests 120 are within the vicinity (e.g., boundary distance) of the personalized vending machine 100 via one or more of the sensing methods discussed above. The personalized vending machine 100 may then determine the qualifications needed (e.g., wizard hat 302, astronaut hat 304, baseball hat 306), and may enable the two or more guests 120 to purchase or otherwise obtain the available items of merchandise 204a, without determining the identity of the two or more guests 120. Thus, a guest 120a may obtain an available item of merchandise 204a by collaborating with one or more additional guests 120b, 120c. In this way, guests 120a, 120b, and 120c may be enticed to interact or collaborate with other guests 120a, 120b, and 120c within the entertainment venue 110, increasing participation.

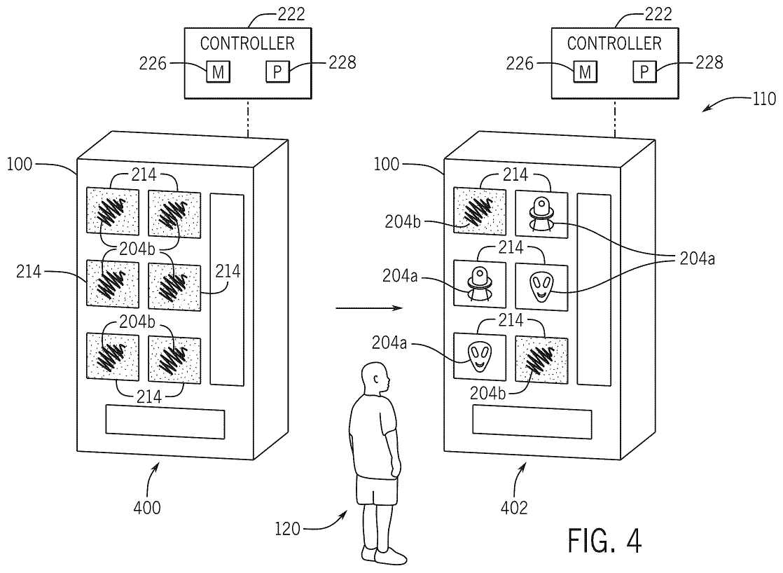

Referring now to FIG. 4, the personalized vending machine 100 may block or otherwise obfuscate viewing of a restricted item of merchandise 204b that may not be available to a guest 120 based on the guest's qualifications and/or identification. For example, in an embodiment where the one or more viewing panels 214 of the personalized vending machine 100 are digital, the one or more viewing panels 214 may hide (e.g., obscure) restricted items of merchandise 204b not available to the guest 120. Specifically, the digital screen may display a recreated digital image of a restricted item of merchandise 204b (e.g., a blurred or distorted image) or may display language indicating the restricted item of merchandise 204b is unavailable (e.g., “ITEM LOCKED”, “SECRET ITEM”) or both. In an embodiment where the one or more viewing panels 214 include transparent digital screens, an overlaid image may be included on the one or more viewing panels 214, blocking out the restricted item of merchandise 204b inside the personalized vending machine 100 from view of the guest 120.

In an embodiment, the one or more viewing panels 214 may include smart glass (e.g., privacy smart glass, privacy glass, switchable glass) capable of transitioning between a transparent configuration and an obscured configuration (e.g., opaque, frosted, blurred, translucent, silhouette). For example, items of merchandise 204 within the personalized vending machine 100, as shown in FIG. 1, may be displayed through the one or more viewing panels 214 to the guest 120. The personalized vending machine 100 may be in “non-viewing” mode 400 (e.g., obscured mode) or an idle mode where the one or more viewing panels 214, including smart glass, may be in an obscured configuration. In this way, one or more restricted items of merchandise 204b within the personalized vending machine 100 may be blocked from viewing by the guest 120 or may not be fully viewed (e.g., may be blurred, translucent, frosted). In an embodiment, in the obscured view, one or more restricted items of merchandise 204b may be silhouetted (e.g., a dark shape of the restricted item of merchandise 204b may be viewable by the guest 120). In this way, the guest 120, without the required qualifications, may be capable of guessing the restricted item of merchandise 204b within the personalized vending machine 100. As will be appreciated, the obscured view of the restricted item of merchandise 204b may motivate or influence the guest 120 to participate in entertainment venue 110 related tasks or rides to obtain the required qualifications.

Upon identification and/or determination of qualifications associated with the guest 120, the personalized vending machine 100 may be configured to transition to a viewing mode 402 (e.g., transparent mode or transparent configuration), enabling the guest 120 to view available items of merchandise 204a that the guest 120 may purchase or otherwise obtain based on the guest's 120 qualifications. For example, upon determining the required qualifications are met, the controller 222 may send a control signal to one or more of the viewing panels 214. The control signal may cause the one or more viewing panels 214 to transition from a frosted view to a transparent view, upon, for example, the application of electricity. In this way, the guest 120 may view the available items of merchandise 204a, based on the guest's 120 qualifications, while blocking from view the restricted items of merchandise 204b.

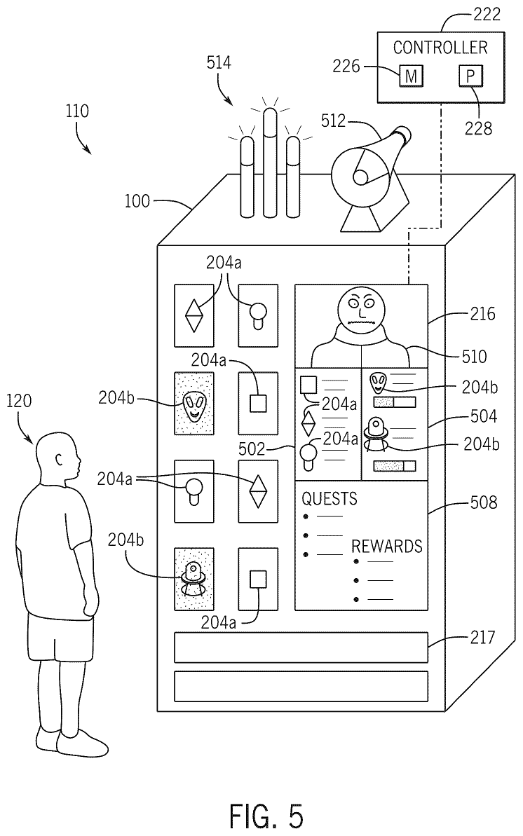

FIG. 5 illustrates an embodiment of the personalized vending machine 100 including details of the selection menu 216. As discussed above, the selection menu 216 may include any size and shape suitable to receive guest 120 input and/or display information pertaining to the personalized vending machine 100 and/or the entertainment venue 110. Further, the selection menu 216 may include any suitable material or type (e.g., LCD, LED, OLED) for displaying the relevant information as discussed above. Further, the selection menu 216 may include touch screen capabilities, where it may receive input from guests 120 and communicate said input to the controller 222 to perform one or more actions. The input may be indicative of a desired item of merchandise 204 within the personalized vending machine 100, as shown in FIG. 1, and/or may be indicative of one or more aspects of the entertainment venue 110.

In an embodiment, the selection menu 216 may include items of merchandise 204 within and/or associated with the personalized vending machine 100. In an embodiment, the selection menu 216 may only include available items of merchandise 204a (e.g., available due to the guest's 120 qualifications) in an available merchandise module 502. For example, the controller 222 may determine the identity and/or qualifications of the guest 120 via any method described in detail in this disclosure. Upon determining the identity and/or qualifications of the guest 120, the controller 222 may cause the selection menu 216 to display available items of merchandise 204a based on the identity and/or qualifications of the guest 120. Further, the selection menu may include relevant information for each available item of merchandise 204a. For example, the selection menu 216 may include price information (e.g., real currency, non-monetary currency), nutritional information, rarity information, dimensional information, or any other suitable information relating to an available item of merchandise 204a. In an embodiment, the price information may be monetary, such as real currency (e.g., domestic currency, digital currency, foreign currency). In an embodiment, the price information may include a non-monetary currency (e.g., achievements, stamps, points, credits associated with one or more aspects of the entertainment venue 110 (e.g., credits pertaining to a game played throughout the entertainment venue 110)). In an embodiment, the price information may include a mixture of monetary currency and non-monetary currency (e.g., $10 and 120 credits).

In an embodiment, selection menu 216 may further include restricted items of merchandise 204b that are not available to the guest 120 in an unavailable merchandise module 504. For example, the selection menu 216 may display a silhouetted version of a restricted item of merchandise 204b not available to the guest 120 based on the identity and/or qualifications of the guest 120. Further, the selection menu 216 may display information related to instructions on how to obtain the relevant qualifications related to a restricted item of merchandise 204b. In an embodiment, the selection menu 216 may display a status bar pertaining to a level needed or status needed for the guest 120 to be able to purchase or otherwise obtain the restricted item of merchandise 204b. In an embodiment, the selection menu 216 may display a map describing where to find items and/or information needed to obtain a qualification, such as collaborating with other guests 120 as described above.

In an embodiment, the selection menu 216 may include a task information module 508 or screen capable of displaying information relevant to a task (e.g., quest, game) associated with the entertainment venue 110. For example, upon determining the identity of the guest 120 in the vicinity (e.g., boundary distance) of the personalized vending machine 100, the task information module 508 may display a list of tasks associated with the guest 120 (e.g., guest's 120 identity), the status of each task, and/or a potential reward for completing each task. The list of tasks may further include instructions (e.g., clues) on how to complete the task, for example, a location of where to find a task item, how to obtain a task item, who to talk to complete the task. The potential reward may be a currently restricted item of merchandise 204b within the personalized vending machine 100, but will become available to the guest 120 after achieving the specific qualifications (e.g., task completion). Thus, the completion of the task by the guest 120 transitions the restricted item of merchandise 204b to an available item of merchandise 204a for the guest 120.

In an embodiment, the personalized vending machine 100 may include an animated character 510, capable of speaking to the guest 120 in a personalized matter, based on the identification of the guest 120 and/or the qualifications of the guest 120. The animated character 510 may be visualized on the selection menu 216 and/or may produce talking sounds from one or more speakers 512 located on or proximate the personalized vending machine 100. For example, upon determining the guest's 120 identity and/or qualifications, the animated character 510 may recite information relevant to the guest 120 (e.g., the guest's 120 current status on a task, the guest's 120 current level) and/or information pertaining to available items of merchandise 204a for the guest 120. In some embodiments, the guest 120 may interact with the animated character 510 with the use of, for example, artificial intelligence and/or voice recognition software. In this way, the animated character 510 may appear to answer the guest's 120 questions or have a conversation with the guest 120.

In an embodiment, the personalized vending machine 100 may include one or more show elements 514 capable of displaying a visual effect. For example, when the controller 222 determines the guest 120 within the vicinity of the personalized vending machine 100 has completed a task, leveled up, or otherwise now obtains a new qualification, the controller 222 may send a signal to the one or more show elements 514 to display a visual effect (e.g., a light show). Further, the controller 222 may send a control signal to the one or more speakers 512 and/or the selection menu to produce noise and/or display a visual effect (e.g., display “congratulations”, produce a sound saying “congratulations”).

Similarly, when the controller 222 determines the guest 120 has purchased or otherwise obtained an available item of merchandise 204a from the personalized vending machine 100, the controller 222 may send a signal to the one or more show elements 514, the one or more speakers 512, and/or the selection menu to display a visual effect and/or produce a sound.

In an embodiment, the visual effect and/or sound produced may be associated with the qualification obtained and/or item of merchandise purchased or otherwise obtained. For example, upon purchasing an available item of merchandise 204a that is an alien-themed plush toy, the personalized vending machine 100 may produce alien-like music, via the one or more speakers 512, and a corresponding alien-like light show, via the one or more show elements 514 and/or the selection menu 216. In this way, guests 120 around the personalized vending machine 100 may be alerted to the accomplishments of the guest 120 purchasing the available item of merchandise 204a, which may result in increased entertainment venue participation or interaction.

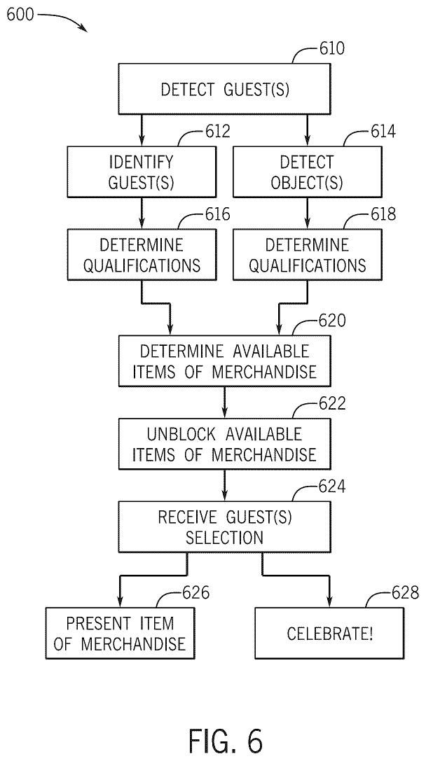

Turning to FIG. 6, a flow chart for a process 600 of displaying and enabling purchasing available items of merchandise 204a within an embodiment of the personalized vending machine 100, as shown in FIG. 2, is described. As will be appreciated, the steps included in the flow chart may be performed by a controller comprising a memory component and one or more processors.

Referring to block 610, the personalized vending machine 100 may detect the presence of a guest and or guests within the vicinity (e.g., boundary distance) of the personalized vending machine 100. Specifically, the personalized vending machine 100 may determine whether a guest or guests are physically near (e.g., within 1 meter (m), 2 m, 3 m, 4 m, 5 m, 6 m, etc.) the personalized vending machine 100. For example, the personalized vending machine 100 (e.g., the controller of the personalized vending machine 100) may include a predetermined boundary distance (e.g., threshold distance) around the personalized vending machine 100, where upon a guest or guests crossing the boundary distance (e.g., threshold distance), the controller may determine that the guest or guests are in the vicinity of the personalized vending machine 100. Detection may be performed through any of the methods discussed in detail above, such as video/image sensors, proximity sensors, motion sensors, noise sensors, and/or other suitable methods.

Upon detecting the guest(s) in block 610, the personalized vending machine 100 may then determine the identity of the guest(s) in block 612. For example, the personalized vending machine 100 may utilize sensor data (e.g., video/image sensor data, voice sensor data, etc.) to detect data indicative of an identity of the guest(s). The data may be sent or otherwise communicated to the controller, where the controller may determine the guest(s) identity or identities (e.g., determine by matching the detected data with stored data in the controller's memory (e.g., pattern matching, facial recognition, pattern recognition)). As discussed above, in an embodiment, the personalized vending machine 100 may not perform the steps of block 612, and may instead detect an object without detecting the identity of the guest(s), as shown in block 614.

For example, after detecting the guest(s) in block 610, the personalized vending machine 100 may then determine, via, for example, object recognition, an object associated with the guest(s). As discussed above, the object may include a mobile device (e.g., mobile phone), toy (e.g., plush toy, plastic toy, etc.), task item (e.g., quest item), apparel (e.g., entertainment venue themed hat, shirts, jewelry etc.) and so forth. In an embodiment where the object is a mobile device, the personalized vending machine 100 may be capable of detecting data (e.g., rewards data) associated with an app of the mobile device via, for example, a generated QR code or near field communication. As discussed above, the personalized vending machine 100 may detect the object through any suitable means, such as sensors detecting image data, video data, sound data, and/or by communicating directing (e.g., NFC) with one or more communication components associated with the object.

Returning to block 612, after determining the identity or identities of the guest(s), the personalized vending machine 100 may determine one or more qualifications (e.g., status, level) associated with the identity or identities in block 616. The identity or identities of the guest(s) may have associated qualifications through, for example, participating in games (e.g., entertainment venue games), participating in tasks (e.g., entertainment venue task, entertainment venue quests), participating in an app (e.g., app on a mobile device), and so forth. For example, as discussed above, a guest may receive an achievement for finding a specific or hidden location within the entertainment venue, where the achievement may then be associated with identity of the guest.

Returning to block 614, in an embodiment where the personalized vending machine 100 does not determine the identity of the guest(s), after detecting the object associated with the guest(s), the personalized vending machine 100 may determine one or more qualifications (e.g., status, level, achievement) associated with the object. For example, the object may include associated qualifications through, for example, participating games (e.g., entertainment venue games), participating in tasks (e.g., entertainment venue task, entertainment venue quests), participating in an app (e.g., app on a mobile device), and so forth. Specifically, as discussed above, the object may be a reward for completing an entertainment venue themed quest, where the object (e.g., reward) may be further utilized as a qualification for the personalized vending machine 100 to purchase or otherwise obtain available items of merchandise.

After determining the qualifications based on the identification in block 616, the detection of the object in block 618, or both, the personalized vending machine 100 may then determine available (e.g., eligible) items of merchandise based on the qualifications in block 620. For example, the personalized vending machine 100 may include a variety of items of merchandise that may require various qualifications to be purchased or otherwise obtained. As discussed above, and as an example, an available item of merchandise may require a certain entertainment park level (e.g., qualification), such as level 50, to be purchased or otherwise obtained. The personalized vending machine 100 may compare the qualifications of the guest (e.g., level 60) to the required qualifications (e.g., level 99) of each item of merchandise present in the personalized vending machine to determine what items of merchandise are available items of merchandise eligible to be purchased by the guest.

After determining what items of merchandise are available items of merchandise to the guest, the personalized vending machine 100 may unblock, make available, and/or display the available items of merchandise in block 622. That is, the personalized vending machine 100 may display available items of merchandise on one more viewing panels and/or a selection menu. In an embodiment utilizing smart glass for the one or more viewing panels, upon determining the available items of merchandise, the personalized vending machine 100 may transition the smart glass from an obscured configuration (e.g., frosted, blurred, translucent, opaque, silhouetted, semi-transparent) to a transparent configuration to enable the guest(s) to view the available items of merchandise. The personalized vending machine 100 may further enable the selection menu, user device, or other device to receive input by the guest(s) indicative of a desired available item of merchandise. Further, the personalized vending machine 100 may disable from view restricted items of merchandise via the frosted configuration of the one or more viewing panels.

Referring now to block 624, the personalized vending machine 100 may receive input from the guest(s) indicative of a desired selection (e.g., desired item of merchandise from the available items of merchandise). In an embodiment, the input may be received at the selection menu or the one or more viewing panels. In an embodiment, the input may be received on a mobile device associated with the guest(s), and communicated to the personalized vending machine 100 via one or more suitable methods of communication (e.g., NFC, WiFi, Bluetooth). Further, at block 624, before, after, or simultaneously with receiving the input from the guest(s), the personalized vending machine 100 may receive a payment (e.g., payment for the item of merchandise) from the guest(s). In an embodiment, the payment may include a monetary payment, such as real currency (e.g., domestic currency, crypto, foreign currency). In an embodiment, the payment may include a non-monetary currency (e.g., credits associated with one or more aspects of the entertainment venue (e.g., credits pertaining to a game played throughout the entertainment venue)). In an embodiment, the payment may include a mixture of monetary currency and non-monetary currency (e.g., $10 and 120 credits). In an embodiment, the payment may be the same as the guest qualification or at least partially associated with the guest qualification. In any case, the personalized vending machine 100 may receive the payment digitally or may receive the payment physically. The controller may receive an indication of the non-monetary payment. It should be noted that payment may not be needed, and the qualifications, as discussed above, may be sufficient to obtain available items of merchandise.

Upon receiving the guest(s) input in block 624, and optionally the payment, the personalized vending machine 100 may actuate or trigger one or more actuators to present the item of merchandise to the guest(s) in block 626. The personalized vending machine 100 may present the merchandise to the guest(s) utilizing any suitable method, such as one or more of the above described methods (e.g., robotic arm).

Before, after or simultaneous with block 626, the personalized vending machine 100 may produce one or more visual or noise effects in block 628. For example, the personalized vending machine 100 may display one or more celebratory or themed (e.g., entertainment venue themed, item of merchandise themed) visual effects via, for example, one or more show components. Further, as discussed above, the personalized vending machine 100 may produce one or more congratulatory or themed noises via one or more speakers located on, in, and/or proximate the personalized vending machine 100. It should be noted that any of the above blocks may be performed at any time during the process 600, and are not limited to the order as discussed. For example, blocks 626 and 628 may be performed simultaneously with one another. As another example, the personalized vending machine 100 may perform blocks 612 and 614 simultaneously with one another. That is, the personalized vending machine 100 may simultaneously determine an identification of a guest while detecting an object associated with the guest.

While only certain features of the disclosure have been illustrated and described herein, many modifications and changes will occur to those skilled in the art. It is, therefore, to be understood that the appended claims are intended to cover all such modifications and changes as fall within the true spirit of the disclosure. It should be appreciated that any features shown and described with reference to FIGS. 1-6 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A vending machine, comprising:
a housing configured to store one or more items of merchandise, wherein the one or more items of merchandise include at least one or more available items of merchandise or one or more restricted items of merchandise; and
a controller, the controller configured to:
determine one or more qualifications of a guest;
present, via a display in a transparent configuration, the one or more available items of merchandise to the guest based on the one or more qualifications of the guest;
present, via a display in an obscured configuration, the one or more restricted items of merchandise to the guest;
receive an indication of a choice from the guest indicative of a selected item of merchandise, wherein the selected item of merchandise is within the one or more available items of merchandise; and
trigger the provision of the selected item of merchandise to the guest via a pickup port.

2. The vending machine of claim 1, wherein the controller is configured to:
determine an identity of the guest; and
determine the one or more qualifications of the guest based on the identity of the guest.

3. The vending machine of claim 2, comprising one or more sensors configured to detect data indicative of the identity of the guest, and wherein the controller is configured to:
receive the detected data from the one or more sensors; and
determine the identity of the guest based on the detected data.

4. The vending machine of claim 3, wherein the one or more sensors comprise at least a visual sensor, an audio sensor, or a proximity sensor.

5. The vending machine of claim 1, wherein the controller is configured to:
identify an object associated with the guest; and
determine the one or more qualifications of the guest based on the object.

6. The vending machine of claim 5, comprising one or more sensors configured to detect data indicative of a presence of the object, and wherein the controller is configured to:
receive the detected data from the one or more sensors; and
identify the object associated with the guest based on the detected data.

7. The vending machine of claim 1, further comprising one or more sensors, wherein the one or more sensors are configured to detect data indicative of a location of the guest, and wherein the controller is configured to:
determine the location of the guest is within a boundary distance from the vending machine; and
determine the one or more qualifications of the guest within the boundary distance.

8. The vending machine of claim 1, wherein the display comprises one or more viewing panels, and wherein the controller is configured to:
control the one or more viewing panels to display the available items of merchandise to the guest based on the one or more qualifications using the transparent configuration; and
control the one or more viewing panels to display the restricted items of merchandise to the guest based on the one or more qualifications using the obscured configuration.

9. The vending machine of claim 1, wherein the display comprises a selection menu capable of displaying the available items of merchandise as selectable icons and displaying the restricted items of merchandise as non-selectable icons.

10. The vending machine of claim 1, wherein the controller is configured to:
receive a selection of the one or more available items of merchandise via the display.

11. The vending machine of claim 1, wherein upon receiving the indication of the choice from the guest, the controller is configured to receive a non-monetary payment from the guest based on the selected item of merchandise.

12. The vending machine of claim 1, wherein the guest is a first guest, and the one or more qualifications comprise the first guest collaborating with a second guest.

13. A method for vending, the method comprising:
determining one or more qualifications associated with a guest;
determining one or more available items of merchandise based on the qualifications;
displaying the one or more available items of merchandise through one or more viewing panels disposed on a vending machine in a transparent configuration;
displaying one or more restricted items of merchandise through one or more viewing panels disposed on the vending machine in an obscured configuration;
receiving a guest input indicative of a desired item of merchandise, wherein the desired item of merchandise is within the one or more available items of merchandise; and
presenting the desired item of merchandise to the guest.

14. The method of claim 13, comprising:
determining an identity of the guest, wherein the one or more qualifications are associated with the identity of the guest.

15. The method of claim 13, comprising:
detecting a physical feature of the guest, wherein determining one or more qualifications associated with the guest is based on the physical feature of the guest.

16. The method of claim 13, comprising:
detecting an object associated with the guest, wherein the one or more qualifications are associated with the object.

17. The method of claim 16, wherein the object is one or more items of apparel worn by the guest.

18. The method of claim 13, comprising:
performing one or more celebratory actions upon receiving the guest input, wherein the one or more celebratory actions are based on the guest input.

19. A vending machine for an entertainment venue, the vending machine comprising:
one or more items of merchandise;
one or more viewing panels, wherein the one or more viewing panels are configured to transition between an obscured configuration and a transparent configuration upon receiving an electrical signal; and
a controller configured to:
determine one or more qualifications of a guest, wherein the one or more qualifications comprise completing one or more actions associated with the entertainment venue; and
send the electrical signal to the one or more viewing panels based on the one or more qualifications.

20. The vending machine of claim 19, wherein the controller is further configured to:
receive a selection from the guest indicative of an available item of merchandise, wherein the available item of merchandise is associated with the one or more qualifications; and
receive an indication of payment from the guest indicative of the available item of merchandise, wherein the payment is non-monetary.
